(19) United States
(12) Patent Application Publication
(10) Pub. No.: US 2008/0299340 A1
(43) Pub. Date: Dec. 4, 2008

(54) OVER-MOLDED THICK WALL PARTS

(76) Inventors: Joseph Kamienski, Pittsfield, MA (US); Andrew W. May, East Greenbush, NY (US)

Correspondence Address: SABIC - 08CT;SABIC Innovative Plastics - IP Legal, ONE PLASTICS AVENUE, PITTSFIELD, MA, 01201-3697, US

(21) Appl. No.: 12/130,131

(22) Filed: May 30, 2008

Related U.S. Application Data
(60) Provisional application No. 60/941,301, filed on Jun. 1, 2007.

(51) Int. Cl. B32B 27/08

(52) U.S. Cl. 428/35.7

(57) ABSTRACT

An over-molded thick wall part, an insert used in forming the over-molded thick wall part, and a method of forming over-molded thick wall parts. The insert includes at least two sides, wherein one of the sides includes a flat surface. With a flat surface, there is a tendency to form sink marks rather than internal shrinkage voids to compensate for the volumetric shrinkage of the resin. Therefore, the flat surface enables the insert to cool without forming voids within the interior of the insert that may adversely affect the aesthetics and/or usefulness of the of the over-molded thick wall part. The cooled insert is then encompassed within an over-molded outer component to form the thick wall part. By using a two step molding process to form the thick wall part, substantial time and/or energy savings may be achieved as compared to prior art methods of forming thick wall parts. Depending on the types of materials used to form the insert and the outer component of the thick wall part, various parts may be formed including lenses, handles, housings and the like.

### CROSS REFERENCE TO RELATED APPLICATIONS

This application claims priority to U.S. Provisional Application No. 60/941,301, filed Jun. 1, 2007, which is hereby incorporated by reference in its entirety.

### FIELD OF INVENTION

The present invention relates to injection-molded parts and, in particular, to injection-molded, over-molded thick wall parts and methods of making these parts.

### BACKGROUND OF INVENTION

Thick-walled plastic parts are found in a wide array of applications. Examples of such applications include ophthalmic lenses, aspheric lenses, projector lenses, cosmetic packaging, handles, plumbing fixtures, gears, pulleys, and computer and electronics housings. Thick-walled parts offer a number of advantages such as Strength, performance, aesthetics, and/or ergonomics as compared to thinner-walled parts.

To produce a thermoplastic part using an injection molding process, it is often necessary to heat the material to a molten state and inject the material into a mold to form the desired shape. Heat must then be removed from the plastic material to solidify the part so that it may be ejected from the mold without distortion.

However, due to the thickness of the parts, the cooling times for forming these parts can be much higher than for thinner-walled parts. Since the cooling time for a plastic part is exponentially based on the thickness of the part being formed, the thicker the part to be manufactured, the exponentially longer the cooling time needed to make the part, thereby increasing the cost of making the part.

Volumetric shrinkage is inherent in the injection molding process. To compensate for material shrinkage, either an indentation (sink mark) is formed on the surface of the part or internal shrinkage voids (bubbles) are formed within the part as it cools from a molten state to a solid state. In general, as the wall thickness increases, the depth of the sink mark increases and/or the number of shrinkage voids formed also increases. One of the solutions to these problems has been to increase the mold temperature. In these solutions, the mold temperature is set at the upper end or above the temperature range recommended by material suppliers to ensure the gates do not freeze off too soon, thereby stopping flow of plastic material into the mold cavity. This enables processors to run a long ‘Hold’ times to push additional material into the mold cavity and compensate for the shrinkage that occurs as the part cools. Higher mold temperature also reduces the heat transfer rate from the plastic resin into the mold steel that forms the part geometry. This permits shrinkage to occur more uniformly across the part—interior versus exterior.

However, as a result of the lower heat transfer rate, the cooling time increases thereby increasing the manufacturing cost of the product due to the increased energy needed to operate at higher mold temperatures and/or the added time needed to cool the thick walled part.

Accordingly, it would be beneficial to provide a method of forming a thick-walled part that was faster and/or less expensive than prior art methods. It would also be beneficial to provide a method of forming a thick-walled part that was substantially free of sink marks and/or shrinkage voids within the part. It would also be beneficial to provide a thick-walled part that was substantially free of sink marks and/or shrinkage voids, thereby enabling the thick-walled part to be used in a variety of applications wherein the aesthetics and/or functionality of the part were not adversely affected.

### SUMMARY OF THE INVENTION

The present invention addresses the issues associated with the prior art by providing an over-molded thick wall part, an insert used in forming the over-molded thick wall part, and a method of forming over-molded thick wall parts that is faster and/or more energy efficient than prior art methods. The insert includes at least two sides, wherein one of the sides includes a flat surface. With a flat surface, there is a tendency to form sink marks rather than internal shrinkage voids to compensate for the volumetric shrinkage of the resin. Therefore, the flat surface enables the insert to cool without forming voids within the interior of the insert that may adversely affect the aesthetics and/or usefulness of the finished part. The cooled insert is then encompassed within an over-molded outer component to form the thick wall part. By using a two step molding process to form the thick wall part, substantial time and/or energy savings may be achieved as compared to prior art methods of forming thick wall parts. The concepts of the present invention may be used to form a variety of different parts such as ophthalmic lenses, aspheric lenses, projector lenses, cosmetic packaging, handles, plumbing fixtures, gears, pulleys, computer housings, electronics housings and the like.

Accordingly, in one aspect, the present invention provides an over-molded thick wall part including an insert having at least two sides, wherein at least one side includes a flat surface and wherein insert is substantially free of sink marks and/or internal voids and an over-molded outer component, wherein the insert is encompassed within the over-molded outer component; wherein the over-molded thick wall part is substantially free of internal voids; further wherein the insert comprises a first organic polymer and the over-molded outer component comprises a second organic polymer.

In another aspect, the present invention provides an insert having an insert having at least two sides, wherein at least one side includes a flat surface and wherein the insert is substantially free of internal voids; wherein the insert comprises an organic polymer.

In yet another aspect, the present invention provides a method of forming an over-molded thick wall part including the steps of a) injection molding a first organic polymer to form an insert, wherein the insert has at least two sides and wherein at least one side includes a flat surface; further wherein the insert is substantially free of internal voids; b) cooling the insert to a temperature below the heat deflection temperature (HDT) of the first organic polymer; c) over-molding a second organic polymer to form an over-molded outer component that encompasses the insert; and d) cooling the over-molded outer component to form the over-molded thick wall part; wherein the over-molded thick wall part is substantially free of sink marks and/or internal voids.

### BRIEF DESCRIPTION OF THE DRAWINGS

The various embodiments of the present invention can be understood with reference to the following drawings. The components are not necessarily to scale. Also, in the drawings, like reference numerals designate corresponding parts throughout the several views.

FIG. 1 is a cross-sectional view of an over-molded thick-wall part according to one embodiment of the present invention.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of.” Furthermore, all ranges disclosed herein are inclusive of the endpoints and are independently combinable.

As used herein, approximating language may be applied to modify any quantitative representation that may vary without resulting in a change in the basic function to which it is related. Accordingly, a value modified by a term or terms, such as “about” and “substantially,” may not to be limited to the precise value specified, in some cases. In at least some instances, the approximating language may correspond to the precision of an instrument for measuring the value.

The present invention provides an insert used in forming an over-molded thick wall part, an over-molded thick wall part having an insert and an outer component, and a method of forming over-molded thick wall parts. The insert includes at least two sides, wherein one of the sides includes a flat surface. With a flat surface, there is a tendency to form sink marks rather than internal shrinkage voids to compensate for the volumetric shrinkage of the resin. Therefore, the flat surface enables the insert to cool without forming voids within the interior of the insert that may adversely affect the aesthetics and/or structural integrity of the finished part. The cooled insert is then encompassed within an over-molded outer component to form the thick wall part. By using a two step molding process to form the thick wall part, substantial time and/or energy savings may be achieved as compared to prior art one-step methods of forming thick wall parts.

As previously discussed, prior art methods of forming thick-walled parts suffer from several problems. In one aspect, as the wall thickness of the part increases, the time required to cool the plastic material increases exponentially. This may be seen in Equation 1 below.

$$S = \frac{- {t}^{2} {log}_{e}}{2 π α} ( \frac{π ( {T}_{r} - {T}_{m} )}{4 ( {T}_{c} - {T}_{m} )} ) \\ \begin{matrix}S = minimum cooling time \\ t = wall thickness of molding \\ α = thermal diffusivity of material \\ {T}_{r} = ejection temperature of molding \\ {T}_{m} = mold temperature \\ {T}_{c} = cylinder temperature\end{matrix} \qquad Equation 1$$

Since the cooling time is a function of the thickness of the part squared, an increase in the thickness of the part to be formed substantially increases the length of time needed to cool the part. In addition, due to the increase in the length of time needed to cool the part, the cost of manufacturing the thick-wall part also increases.

Another problem with prior art methods is the fact that there is a tendency to form internal shrinkage voids (within the molded part) as the wall thickness increases. Shrinkage is inherent in an injection molding process. As the plastic resin cools from processing temperatures and pressures to ambient conditions, the specific volume of the molded part decreases due primarily to the coefficient of thermal expansion of plastic materials. To compensate, shrinkage voids (or “bubbles”) are sometimes formed inside the part. Shrinkage voids are unacceptable in many applications where part aesthetics are critical. A shrinkage void can also present a problem from a physical property standpoint, as the void reduces mechanical strength in that area of the molded part. In optical applications, voids scatter light and are unacceptable. Additionally, it becomes very difficult to determine if a void is present on a molded part if the resin is opaque. And, due to the greater amount of material in thick-walled molded parts, there is a greater likelihood of shrinkage voids than with thin-walled molded parts.

Another means of compensating for volumetric shrinkage is the formation of “sink marks” or indentations in the final product. Sink marks are unacceptable in many applications as they affect dimensional tolerance, performance and/ or aesthetics of the final product. Again, as with shrinkage voids, due to the greater amount of material in thick-walled molded parts, there is a greater likelihood of sink marks in thick-walled molded parts than with thin-walled molded parts.

By using a two-step over-molding process to form the thick-walled parts of the present invention, several advantages may be achieved. First, since the wall thickness of the over-molded outer component is reduced (due to the presence of the insert), the cooling time needed to cool the outer component will decrease. And as the cooling time needed to cool the insert is also reduced as compared to the overall part due to the thickness of the insert, using a two-step process actually results in a manufacturing time for forming the insert and the outer component that combined is less than the manufacturing time needed to form a thick-walled part using the one-step process of the prior art.

A second advantage of the two-step molding process of the present invention is that since the process uses a cooled insert, the insert is at a lower temperature than the over-molded plastic outer component after the outer component has been formed around the insert, thereby enabling the insert to help cool the outer component from the inside as well as cooling associated with the molding surfaces of the tool. As a result, the dual cooling further reduces the cooling time of the thick-walled part.

Lastly, the use of one or more flat surfaces on the insert helps prevent shrinkage voids from forming. The flat surface on the insert will tend to sink (deform) to compensate for material shrinkage rather than forming internal shrinkage voids. This is due to the inherent strength differences between a domed surface and a flat plane. Since the insert is substantially free from shrinkage voids due to the use of flat surfaces on the insert, when the over-molded outer component is added, there is less chance for shrinkage voids to form in the overall part since the inner core is already substantially free of any shrinkage voids from the first step of the process. Conversely, with the one-step process, shrinkage voids and/or sink marks may form in any portion of the part during cooling due to the fact that the entire part must cool, not just the outer component. The use of one or more flat surfaces on the insert also results in an increase in the yield of insert molding by helping to reduce scrap rates by minimizing and/or eliminating shrinkage voids.

Accordingly, in one aspect, the present invention provides an insert that is formed such that at least one side of the insert includes a flat surface. The flat surface induces the formation of a sink mark as heat is removed during cooling of the insert without the formation of shrinkage voids. By placing flat surfaces on at least one side of the insert, during cooling of the insert, the sink will deform inward during the shrinkage rather than permitting shrinkage voids to form. As such, the resulting insert is substantially free of any shrinkage voids. As used herein, “substantially free of shrinkage voids” refers to an insert that has no shrinkage voids that are capable of being seen by an unaided eye.

In one embodiment, the insert has a flat surface on one side of the insert. In another embodiment, the insert has a flat surface on at least two sides of the insert. In yet another embodiment, especially those embodiments wherein the thick-walled part is a lens, the insert may include one side that is curved in shape. In another embodiment, the insert may include two sides that are curved in shape. In those embodiments wherein the insert includes one or more curved sides, the flat side constitutes all or substantially all of one side of the insert or, in an alternative embodiment, when the flat surface is part of a curved side, the flat surface may constitute only a small portion of the curved side. In those embodiments wherein the insert includes a curved side and a flat surface on the curved side, the upper portion of the curved side will be flattened rather than curved to permit a flat side to be located on the curved side.

The insert may be formed from any organic polymer capable of being used in an injection-molding process to form an insert that may then be used to form an over-molded thick wall part. The organic polymer may be a crystalline polymer or an amorphous polymer. The organic polymer used in the insert may be selected from a wide variety of thermoplastic resins or blends of thermoplastic resins. The organic polymer may also be a blend of polymers, copolymers, terpolymers, or combinations including at least one of the foregoing organic polymers. Examples of organic polymers that may be used in the present invention include, but are not limited to, polyacetals, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, or the like, or a combination including at least one of the foregoing organic polymers. The specific organic polymer used for the insert may be selected based on one or more factors including, but not limited to, the type of thick-walled part to be formed, the refractive index of the organic polymer, the thickness of the insert, the thickness of the thick-walled part, the material used for the over-molded outer component, or a combination including one or more of the foregoing factors.

As discussed, the over-molded outer components, and therefore the final over-molded thick-walled parts of the present invention, are beneficially formed using an injection molding process. Nevertheless, the concepts of the present invention may be carried out using any known molding process capable of forming an over-molded thick wall part from an organic polymer using an insert and wherein the resulting thick-walled part is substantially free of sink marks and/or shrinkage voids. As with the insert, the term “substantially free of shrinkage voids” refers to a thick-walled part that has no shrinkage voids that are capable of being seen by an unaided eye.

In another aspect, the present invention provides an over-molded thick wall part that includes the insert. The over-molded thick wall part further includes an over-molded outer component that encompasses the insert. As used herein, an insert that is “encompassed” within an over-molded outer component is one that is located substantially within the outer component. As such, in one embodiment, the entirety of the insert is located within the outer component. However, in another embodiment, the term “encompassed” also includes those embodiments wherein a small percentage of the surface area of the insert, 5% or less, is located outside the outer component. These embodiments may result when, depending on the size and/or shape of the insert, the size and/or shape of the outer component and/or the type of molding process used to form the thick-walled part, small sections of the insert may not be completely encompassed within the outer component. Another embodiment, the term “encompassed” also includes a laminate style embodiment wherein the insert is located between two or more layers of the outer component. In still another embodiment, the term “encompassed” also includes a laminate style embodiment wherein the insert comprises half of the outer component geometry or wall thickness, with the insert forming one side of the final part geometry. Nevertheless, the advantages of using the two-step process remain, namely reduced cooling time for the outer component and/or cooling of the outer component from the inside due to the presence of the insert.

The outer-component may have any shape needed to form the selected thick-wall part. As the outer portion of the part, the outer component will include the selected features of the thick-wall part. For example, in those embodiments wherein the thick-wall part is a lens, one or two sides of the outer component may be curved. In those embodiments wherein the thick wall part is a handle, the outer component will be shaped based on the selected shape of the handle. The shape of the outer component is not dependent on the shape of the insert but is based primarily on the selected utility of the final thick-wall part. Other factors that may be considered in determining the shape of the outer component include, but are not limited to, the type of material used for the insert, the type of material used for the outer component and/or the type of process used to form the thick-wall part.

The over-molded outer component may be formed from any organic polymer capable of being used in an injection-molding process to form an over-molded outer component capable of encompassing an insert to form an over-molded thick wall part. The organic polymer may be a crystalline polymer or an amorphous polymer. The organic polymer used in the over-molded outer component may be selected from a wide variety of thermoplastic resins or blends of thermoplastic resins. The organic polymer may also be a blend of polymers, copolymers, terpolymers, or combinations including at least one of the foregoing organic polymers. Examples of organic polymers that may be used in the present invention include, but are not limited to, polyacetals, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, or the like, or a combination including at least one of the foregoing organic polymers. The specific organic polymer used for the over-molded outer component may be selected based on one or more factors including, but not limited to, the type of thick-walled part to be formed, the refractive index of the organic polymer used in the insert and/or the over-molded outer component, the thickness of the insert, the thickness of the thick-walled part, the material used for the insert, or a combination including one or more of the foregoing factors. In one embodiment, the over-molded outer component is comprised of the same material used to form the insert. In an alternative embodiment, the over-molded outer component is comprised of a different material than the one used to form the insert.

As with the insert, the inserts of the present invention are beneficially formed using an injection molding process. Nevertheless, the concepts of the present invention may be carried out using any known molding process, such as compression molding, capable of forming an insert from an organic polymer wherein the insert is substantially free of any shrinkage voids.

In another aspect of the present invention, a method is provided for forming the over-molded thick wall parts. In one embodiment, the method involves a two-step injection molding process. In the first step, the insert is formed using injection molding and then cooled. The cooled insert is then used in an over-molding injection molding step wherein the outer component is injected molded around the cooled insert to encompass the insert within the outer component and thereby form the final thick-walled part.

Since the two step process forms two thinner parts to form the thick-walled part rather than a single thicker part, and due to the fact that cooling of an injection-molded organic polymer is exponentially higher as the thickness of the part increases, the two-step process of the present invention forms the final part in a lower combined time for the two molding steps than the time needed to form the thick part in a single molding step process.

In one embodiment, insert is formed in an injection molding process and then cooled. The insert is formed such that it includes at least one sink to reduce shrinkage voids during cooling of the insert. In one embodiment, during cooling of the insert, the insert is cooled below a heat deflection temperature (HDT) of the organic polymer used to form the insert. As such, the insert may then be used in the second step of the process without a substantial likelihood of the insert forming shrinkage voids due to being reheated by the organic polymer used to form the outer component during the second step.

As one insert is formed and cooled, a previously formed and cooled insert may be utilized in the second step of the process, wherein the over-molded outer component is injection molded such that it encompasses the insert, thereby forming the thick-walled insert. As such, in one embodiment, an assembly line-like process can be used to form the thick walled parts wherein the insert is formed and then cooled and then used to form the thick-wall part in the second step of the process.

The methods of the present invention are especially advantageous in the formation of thick-walled parts. As used herein, a “thick-wall part” is one having a thickness at its greatest point of 0.25 inches or greater. In another embodiment, a “thick-wall part” is one having a thickness at its greatest point of 0.5 inches or greater. In yet another embodiment, a “thick-wall part” is one having a thickness at its greatest point of 0.75 inches or greater. In still another embodiment, a “thick-wall part” is one having a thickness at its greatest point of 1 inch or greater.

The methods of the present invention may be used to form a variety of different thick-walled parts including, but not limited to, ophthalmic lenses, aspheric lenses, projector lenses, cosmetic packaging, handles, plumbing fixtures, gears, pulleys, computer housings, electronics housings and the like. If the same organic polymer is used for the insert as for the outer component, the finished thick wall part will be substantially free of voids and will have use materials having the same or substantially similar refractive indexes, thereby enabling lenses to be formed. Alternatively, if different organic polymers are used, a less expensive polymer may be used as the insert thereby enabling less expensive thick-walled parts to be formed that have the aesthetics of the more expensive outer component organic polymer, but are less expensive and/or time consuming to manufacture than a one-step process using only the outer component organic polymer only to form the thick-walled part.

The foregoing and other features of the present invention will be more readily apparent from the following detailed description and drawings of the illustrative embodiments of the invention wherein like reference numbers refer to similar elements.

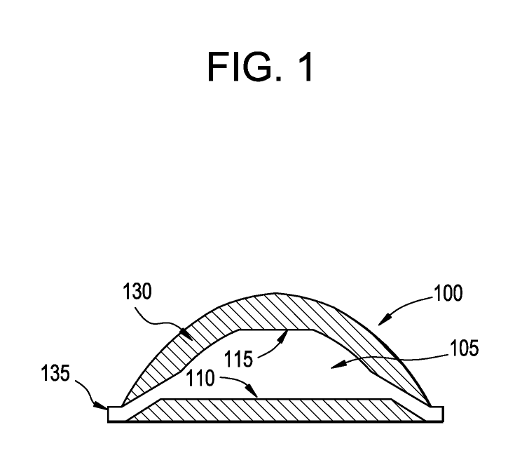

One embodiment of a thick-walled part that may be formed using the concepts of the present invention is shown in FIG. 1. In FIG. 1, a cross-sectional view is provided of a thick-walled part 100. In this embodiment, the thick-walled part 100 is a lens. As may be seen, the lens 100 includes an insert 105 having a first side 110 and a second side 115. The first side 105 is curved, but also includes a sink 120 or substantially flat surface on a portion of the curved side 105. The second side 115 also includes a sink 125.

The lens 100 also includes an over-molded outer component 130 that encompasses the insert 105. In this embodiment, the insert 105 is not completely encompassed within the outer component 130 as the insert includes legs 135, a portion of which are located outside the outer component 130. Also, as may be seen in this embodiment, the shape of the outer component 130 is not contingent on the shape of the insert 105 but rather takes the shape of the selected thick-wall part 100. Since the thick-wall part is a lens, one side of the outer component 130 is completely curved (unlike the corresponding side of the insert 105). In addition, while FIG. 1 may appear to show different materials for the insert 105 and the outer component 130, these differences are provided to enable a better view of the over-molded part and it is contemplated that when the part 100 is a lens, the material used for the insert 105 is the same or has substantially the same refractive index as the material used for the outer component 130.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

1. An over-molded thick wall part comprising:
a) an insert having at least two sides, wherein at least one side includes a flat surface and wherein the insert is substantially free of sink marks and/or internal voids; and
b) an over-molded outer component, wherein the insert is encompassed within the over-molded outer component;
wherein the over-molded thick wall part is substantially free of sink marks and/or internal voids;
further wherein the insert comprises a first organic polymer and the over-molded outer component comprises a second organic polymer.

2. The over-molded thick wall part of claim 1, wherein the first organic polymer and the second organic polymer comprise the same organic polymer.

3. The over-molded thick wall part of claim 1, wherein the first organic polymer and the second organic polymer comprise different organic polymers.

4. The over-molded thick wall part of claim 1, wherein the insert includes a flat surface on at least two sides.

5. The over-molded thick wall part of claim 1, wherein at least one side of the insert is curved and wherein at least one side is substantially flat.

6. The over-molded thick wall part of claim 1, wherein at least two sides of the insert are curved.

7. The over-molded thick wall part of claim 1, wherein at least one side of the over-molded thick wall part is curved and wherein at least one side of the over-molded thick wall part is substantially flat.

8. The over-molded thick wall part of claim 1, wherein at least two sides of the over-molded thick wall part are curved.

9. The over-molded thick wall part of claim 1, wherein the over-molded thick wall part is selected from an ophthalmic lens, an aspheric lens, a projector lens, cosmetic packaging, a handle, a plumbing fixture, a gear, a pulley, a computer housing, an electronics housing, or a combination thereof.

10. An insert comprising:
an insert having at least two sides, wherein at least one side includes a flat surface and wherein the insert is substantially free of sink marks and/or internal voids;
wherein the insert comprises an organic polymer.

11. The over-molded thick wall part of claim 10, wherein the organic polymer is selected from polyacetals, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, or a combination including at least one of the foregoing organic polymers.

12. The over-molded thick wall part of claim 10, wherein the insert includes a flat surface on at least two sides.

13. The over-molded thick wall part of claim 10, wherein at least one side of the insert is curved and wherein at least one side is substantially flat.

14. The over-molded thick wall part of claim 10, wherein at least two sides of the insert are curved.

15. A method of forming an over-molded thick wall part comprising the steps of:
a) injection molding a first organic polymer to form an insert, wherein the insert has at least two sides and wherein at least one side includes a sink; further wherein the insert is substantially free of sink marks and/or internal voids;
b) cooling the insert to a temperature below the heat deflection temperature of the first organic polymer;
c) over-molding a second organic polymer to form an over-molded outer component that encompasses the insert; and
d) cooling the over-molded outer component to form the over-molded thick wall part;
wherein the over-molded thick wall part is substantially free of internal voids.

16. The method of claim 16, wherein the first organic polymer and the second organic polymer comprise the same organic polymer.

17. The method of claim 16, wherein the first organic polymer and the second organic polymer comprise different organic polymers.

18. The method of claim 16, wherein the insert includes a flat surface on at least two sides.

19. The method of claim 16, wherein at least one side of the insert is curved and wherein at least one side is substantially flat.

20. The method of claim 16, wherein at least two sides of the insert are curved.

21. The method of claim 16, wherein at least one side of the over-molded thick wall part is curved and wherein at least one side of the over-molded thick wall part is substantially flat.

22. The method of claim 16, wherein at least two sides of the over-molded thick wall part are curved.

23. The method of claim 16, wherein the over-molded thick wall part is selected from an ophthalmic lens, an aspheric lens, a projector lens, cosmetic packaging, a handle, a plumbing fixture, a gear, a pulley, a computer housing, an electronics housing, or a combination thereof
